(19) United States
(12) Patent Application Publication
(10) Pub. No.: US 2007/0089227 A1
(43) Pub. Date: Apr. 26, 2007

(54) Transfer seat with rotatable wing

(76) Inventor: Joseph Battiston, Sutherland, VA (US)

Correspondence Address: John H. Thomas, P.C., 536 Granite Avenue, Richmond, VA, 23226, US

(21) Appl. No.: 11/259,599

(22) Filed: Oct. 26, 2005

(51) Int. Cl. A61G 7/02; A47K 11/06

(52) U.S. Cl. 4/480

(57) ABSTRACT

The invention relates to a device and method for facilitating a portable commode user's transfer onto the commode by providing a transfer seat that includes at least one rotatable wing adjacent at least one side of a portable commode seating platform. The transfer seat includes a frame, a seating platform supported by the frame with an opening, and a human waste receptacle under the opening. The rotatable wing(s) is secured to the transfer seat adjacent to the seating platform.

### FIELD OF THE INVENTION

The present invention relates, in general, to a transfer seat. The transfer seat of the present invention includes at least one rotatable wing.

### BACKGROUND OF THE INVENTION

Bedside or portable commodes typically include tubular frames where the frames support a user above a portable or fixed installation receptacle. More specifically, such commodes include seating platform to support a user or patient above the portable or fixed installation receptacle to support a user or patient. The seating platforms are generally rotatable, removable, or fixed to the frame, but the platform must include an opening to allow a patient to pass waste into the receptacle. These commodes optionally include a back rail to support a patient or for aesthetic reasons and/or a lid that can be selectively placed over the platform opening. It is also known to include arm rails to support or confine the user on the commode. These arm rails may be fixed, adjustable, or removable.

Individuals that are injured, elderly, obese, or have other infirmities find it difficult to use existing bedside or portable commodes. The commodes are constructed so that these users have difficulty moving from a piece of furniture, such as a bed, a wheelchair, or the like to the bedside commode. It is imperative that patients are able to access the commode in a timely manner.

One area of growing concern is the increasing number of significantly obese people. As this population increases, healthcare providers and healthcare product manufacturers have realized numerous shortcomings in existing healthcare products, including portable commodes. Bariatrics, the branch of medicine that deals with the treatment of obesity, is rapidly developing as healthcare providers begin to identify the shortcomings of existing healthcare products. Known commodes are problematic for many patients, including obese patients, for a number of reasons, including the placement of arm rails, gaps between the bed and commode, and the like. There is a need to improve upon the structural and design shortcomings that inhibit an infirm or obese person's ability to use a portable or bedside commode.

Portable or bedside commodes must be structurally sound and easy to use. The commode must be able to support and facilitate the movement of an infirm or obese patient while being sturdy enough to support an obese patient's weight. However, patients using a bedside commode are not necessarily bed ridden and, therefore, may attempt to transfer to the commode from another support surface (couch, wheelchair, etc.) from either side of the commode. Wheelchair-bound patients, in particular, may access a commode from either side, but they may have difficulty transferring to commodes with fixed arm rails.

It is known for a bedside or portable commode to provide a transfer platform. Transfer seats, as such portable or bedside commodes are known, include transfer platforms that are basically extended versions of the seating platforms already found on portable commodes. The seating platform is lengthened to include flat, continuous surfaces to either side of the platform opening in order to create a continuous, planar support. In use, a patient can slide across the support from either side of the commode receptacle in order to position themselves above the receptacle.

The problems with these continuous, planar supports are numerous. For instance, the fixed length platform makes it difficult to position the commode adjacent to a patient based on room size, furniture arrangements, or the like. Merely extending the seating platform to either side of the receptacle also precludes arm rails to restrain or support a patient. The fixed width of the platform means the commode may have to be disassembled in order to move it from one location to another. Other problems are apparent to one skilled in the art.

It is also known to include bedside toilets with rotatable platforms extending to the rear of the toilet to assist a patient's transfer onto the toilet. Rear positioned platforms are impractical and/or of very little use to a typical patient based on one or more of the above shortcomings. For instance, the transfer seat cannot be placed alongside the bed because the platform extends to the posterior of the toilet. A toilet with a posteriorly placed platform does not facilitate a patient's access to the commode from the sides of the commode, which is the more typical approach.

There is a need for a bedside or portable commode that facilitates a patient's transfer onto the commode that is effective yet simple and relatively inexpensive. Ideally, an improved transfer seat would provide means to transfer to a commode from either side of the commode. A transfer seat in accordance with the present invention includes a rotatable wing or pair of wings adjacent to one or both sides of a seating platform. The subject transfer seat facilitates a patient's transfer from a support surface onto the commode while overcoming one or more of the shortcomings found in existing bedside commodes and transfer seats.

### SUMMARY OF THE INVENTION

In accordance with the present invention, a transfer seat is provided that includes at least one rotatable wing adjacent to at least one side of a seating platform. The transfer seat includes a frame, a receptacle or a waste diverting splash guard, and a seating platform supported by the frame over the receptacle or waste diverting splash guard. The seating platform includes an opening for a user or patient to pass waste to the receptacle or to a permanently installed toilet via the waste diverting splash guard. The wing(s) is secured to the frame adjacent to the seating platform. In another preferred embodiment, the wing is secured to the seating platform adjacent the seating platform opening. Regardless of the mounting location, the wing is rotatable through a range of motion.

The transfer seat of the present invention facilitates obese, infirm, elderly or otherwise handicapped individuals access to a commode receptacle. The transfer seat is typically positioned next to a bed, piece of furniture, wheelchair, or other patient support. The wing can be positioned in a substantially horizontal position (or ‘transfer position’) so that it is usable to facilitate a patient's transfer onto the seating platform. In one embodiment, the frame provides some load support when the wing is in the transfer position. In another preferred embodiment, the frame prevents the wing from rotating substantially below a horizontal angle relative to the seating platform. It is envisioned that a less than horizontal angle may be also be provided.

The wing can also be positioned in a substantially vertical (or ‘upright position’) where it simulates a traditional arm rail found on portable commodes. The upright position serves to retain and/or support a patient on the seating platform. Placing the wing in the upright position facilitates transporting the transfer seat. The ability to put the wing in the upright position also allows the transfer seat to be positioned in locations that a fixed length transfer platform would not fit.

The wing moves through a range of motion between the transfer and up positions. In one preferred embodiment, the transfer seat provides two wings where a wing is located on either side of the commode receptacle. Patients can then use the wings in the transfer position to transfer onto the seating platform from either side of the transfer seat. It should be understood that any reference to ‘a wing’ or ‘wings’ herein is intended to include embodiments of the present invention with one or more wings.

In greater detail, a releasable locking mechanism is provided that operates to secure the wing in at least one specific position. One preferred embodiment of the locking mechanism comprises a catch plate secured to the transfer seat and a spring biased plunger. The catch plate includes an arched slot therein that is bounded on one or both ends by annular openings in the catch plate. The wing would be fastened to the frame via a rotating connection. The spring biased plunger passes through the wing and engages the slot and/or annular openings found in the catch plate.

The body of the plunger is cylindrical with at least two distinct diameters. A first, larger diameter would be sized for placement within the annular openings provided by the catch plate but would be too large for movement along the arched slot. A second, smaller diameter would be suitable for movement along the slot. The plunger is actuated by a user by pressing a plastic guard to selectively move the plunger away from the catch plate. The spring bias urges the plunger back into an annular opening when the plunger is aligned with the opening. The mounting location, shape, operation, etc. of the releasable locking mechanism are optional. One skilled in the art will appreciate that different approaches exist.

In use, under the above preferred embodiment, the wing is secured in a position when the larger diameter portion of the plunger is essentially locked in an annular opening provided by the catch plate. To rotate the wing, a user (such as a patient or healthcare provider) actuates the spring biased plunger. The lock is released by rotating the wing whilst the plunger is depressed. Once rotated, the plunger is no longer aligned with an annular opening. The wing can then be rotated with the smaller diameter portion of the plunger moving along the path defined by the arched slot. If a slot is not included, then the plunger would move along the back face of the bracket. When the plunger is again aligned with an annular opening, it automatically extends into the opening due to the spring bias and is locked in place until it is retracted. It is envisioned that a plurality of annular openings could be provided. As such, the wing could be locked in a number of positions. The wing could also extend beyond substantially vertical or below a substantially horizontal position relative to the seating platform. In a preferred embodiment, however, the frame prevents the wing from rotating past a substantially horizontal position. In this embodiment, the frame acts as a brace tc; at least partially support the patient's weight during a transfer to the seating platform.

In another preferred embodiment, the transfer seat includes selectively extendible or telescoping legs relative to the frame. The legs are telescoped to present the seating platform and/or wings at different heights to a patient. Therefore, the transfer seat is height adjustable depending on a user's preferences, the height of the support surface the patient is transferring from, or the like.

In summary, a transfer seat in accordance with the present invention efficiently addresses at least one of the problems associated with prior art portable commodes or transfer seats. The foregoing and additional features and advantages of the present invention will become apparent to those of skill in the art from the following detailed description of a preferred embodiment taken in conjunction with the accompanying drawings.

### BRIEF DESCRIPTION OF THE FIGURES

FIG. 1 is a perspective view of a transfer seat in accordance with one preferred embodiment of the present invention;

FIG. 2 is perspective view thereof wherein frame mounted wings are in the up position;

FIG. 3 is a rear view of a transfer seat in accordance with the present invention;

FIG. 4 is a front view of a transfer seat in accordance with the present invention;

FIG. 5 is an additional front view of a transfer seat wherein a pair of frame mounted wings are in an up position;

FIG. 6 is a front, close-up view of a locking mechanism on a transfer seat in accordance with the present invention; and

FIG. 7 is a side view of a locking mechanism on a transfer seat in accordance with the present invention.

### DETAILED DESCRIPTION OF THE INVENTION

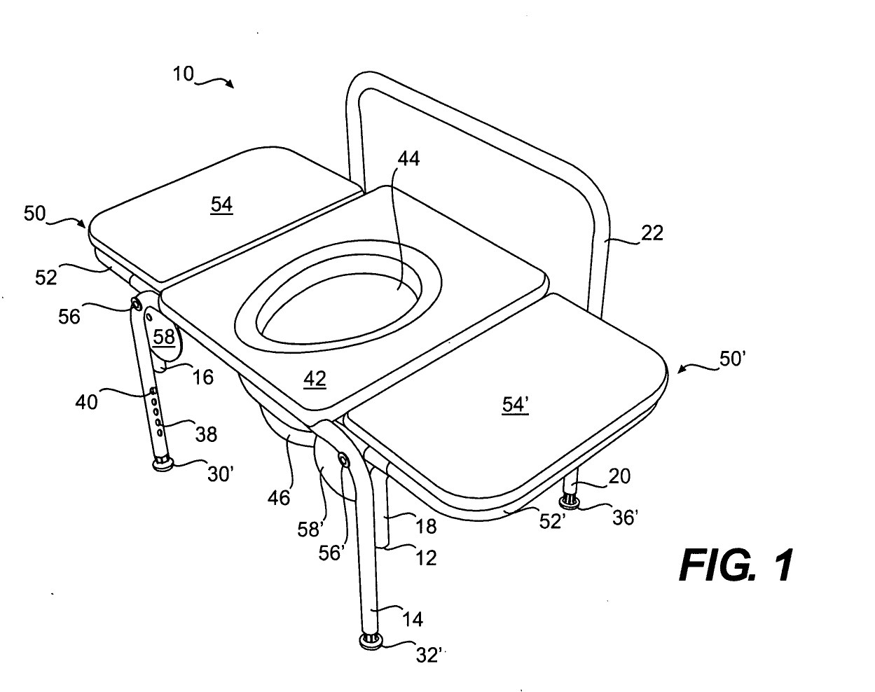

Turning now to a more detailed description of the present invention, there is illustrated in FIGS. 1-3 a preferred embodiment of a transfer seat 10. As illustrated, a frame 12 includes the following frame members: a front bar 14, a left bar 16, a right bar 18, a rear bar 20, a back support 22, a left brace 24, and a rear brace 26. Front bar 14 is connected by left bar 16 and right bar 18 to rear bar 20. The bars and back support are generally inverted, U-shaped pieces in that they each have two vertical portions connected by rounded corners to an upper, horizontal portion. Front bar 14 and rear bar 20 are spaced apart in a parallel relationship. Left bar 16 and right bar 18 are also spaced apart in a parallel relationship. The vertical portions of the left and right bars 16, 18 are secured to corresponding vertical portions on front and rear bars 14, 20 by welding, fasteners, adhesives, or the like.

The vertical portions of back support 22 overlap and are in contact with the vertical portions of rear bar 20. Support 22 is secured to rear bar 20 via welding, fasteners, adhesives, or the like. Back support 22 extends above rear bar 20. A left brace 24 and a right brace 26 increase the structural integrity of rear bar 20. Each brace 24, 26 has two ends where the first ends are connected to a vertical portion of rear bar 20 and the second ends are connected to the horizontal portion of rear bar 20.

The frame members are, in a preferred embodiment, hollow metal tubes bent and cut to the desired shapes and sizes. The members are welded together. It is envisioned, however, that the materials, shapes, and fastening techniques used to form and construct the various frame members and frame might be accomplished numerous ways. The inclusion of a back support and braces are described and illustrated for use with a preferred embodiment only. The placement and form of the frame members should not be limited to the disclosed preferred embodiment. The frame acts as a skeleton for other components of transfer seat 10, as described below, and a support for a patient.

As further illustrated in FIGS. 1-3, front bar 14 and rear bar 20 include telescoping legs identified as elements 30, 32, 34, and 36. Each leg includes a rubber foot identified, respectively, as elements 30′, 32′, 34′ and 36′. Front and rear bars 14, 20 each include a plurality of apertures 38 aligned vertically along their vertical portions.

A push button 40 is associated with each set of apertures 38. Push buttons are well known in the art. Basically, a spring maintains a force on a button. A user actuates a button in order to move two elements in a telescoping relationship. When the button is aligned with an aperture, the spring naturally forces the button into the aperture, temporarily securing the two elements with respect to each other. Here, push buttons 40 on the legs engage one aperture in each set of apertures 38. A user can adjust the height of frame 12, and therefore transfer seat 10, by actuating a push button and extending or retracting a leg in relation to the front and rear bars until the push button engages an aperture in the frame. It is also envisioned that the legs could be locked in place via other mechanisms, such as clips, fasteners, pins, friction fit, or the like. One skilled in the art will appreciate that there are numerous means to secure the telescoping legs.

Having described a preferred embodiment of the frame and legs, the commode features of the transfer seat include a seating platform 42 shaped to nest atop front bar 14 and rear bar 20. A platform opening 44 allows a patient to pass waste into a waste receptacle, including a portable receptacle 46 or an installed, or fixed location, toilet (not shown). If the transfer seat is positioned over an installed toilet, portable receptacle 46 is replaced with a waste diverting splash guard (not shown) that is identical to receptacle 46 save that the bottom of the receptacle is removed. Therefore, receptacle 46 is interchangeable with a waste diverting splash guard and any discussion of the receptacle also applies to the splash guard.

Platform 42 and receptacle 46 can be integrally formed from any number of materials that would be obvious to one skilled in the art. It is also envisioned that receptacle 46 could be a separate element from platform 42 so that it would rest upon additional frame cross members (not shown). Platform 42 could, therefore, be removed from frame 12 and receptacle 46 could be separately removed in order to empty the receptacle. In a preferred embodiment, platform 42 includes rails or slots (not shown) that engage a lip on the receptacle. Receptacle 46 is then selectively attached to platform 42.

The transfer seat of the present invention includes at least one wing located to one side of seating platform 42. As illustrated, two wings 50, 50′ are provided with one wing secured to each side of seating platform 42. The wing or wings can support the weight of a patient, including ly obese patients, transferring to seating platform 42 from a wheelchair, piece of furniture, or the like. It is envisioned that transfer seat 10 may include only one wing to one side of seating platform 42 with either no support or a conventional arm rail located on the opposing side of platform 42. In the embodiment where two wings are employed, the wings are essentially mirror images of each other.

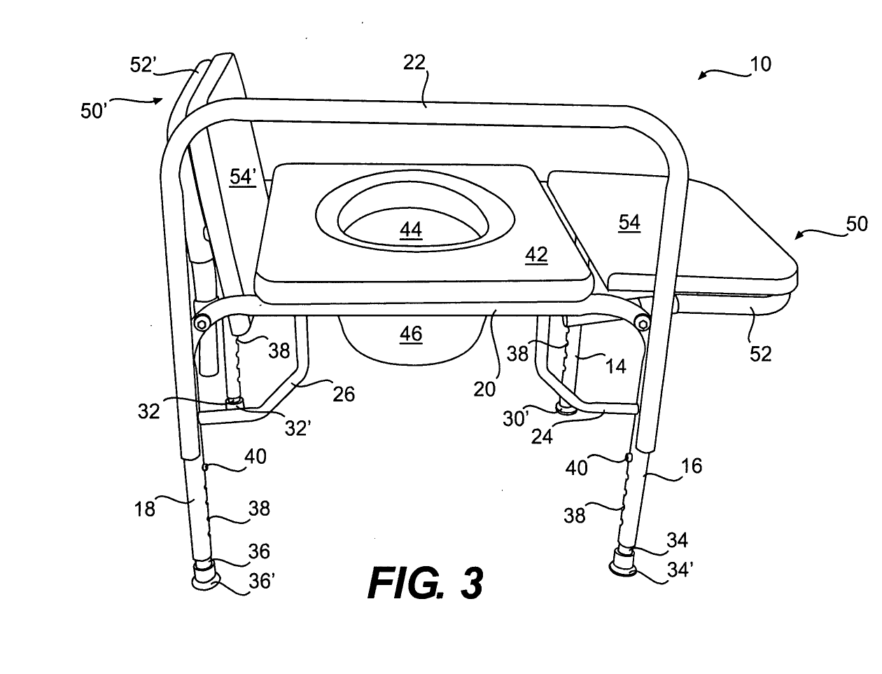

In FIG. 1, transfer seat 10 is illustrated with a left wing 50 and a right wing 50′ both in the transfer position. Each wing in this embodiment includes a wing rail (left wing rail 52 and right wing rail 52′) that are generally U-shaped. The wing rails 52, 52′ are secured to the corresponding upper corners of both front bar 14 and rear bar 20 (see FIG. 3) proximate the two ends of each wing rail. A pair of bolts 56, 56′ connect wings 50, 50′ to front bar 14 in a rotatable manner. Covers 58, 58′ are included, as described further below. Left and right wing rails 52, 52′ support, and are secured to, transfer platforms 54, 54′, respectively.

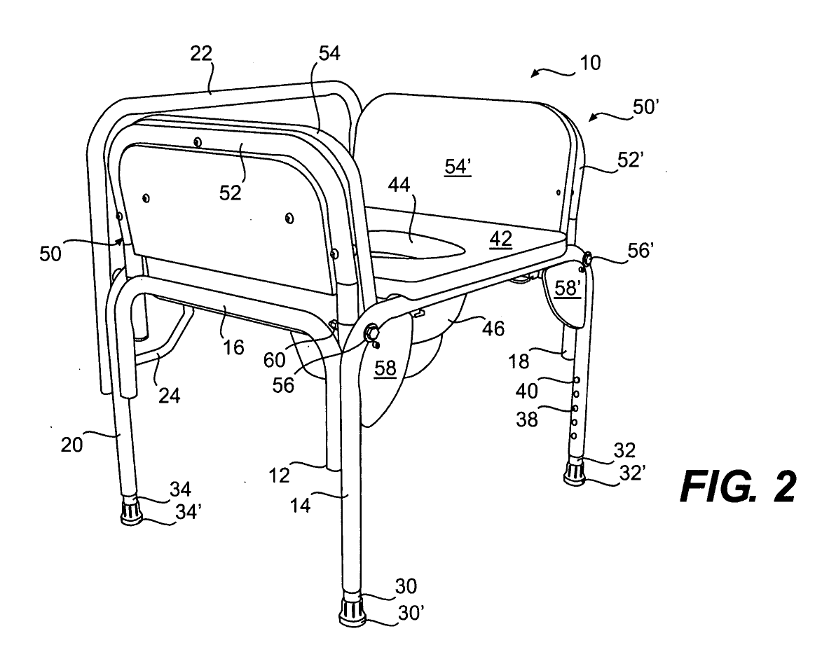

FIG. 2 illustrates left wing 50 and right wing 50′ in a substantially vertical or upright position. As better illustrated herein, bolt 56 passes through front bar 14 and wing rail 52. A nut 60 secures bolt 56. Wing 50 rotates about this connection. Conventional fasteners, such as screws (illustrated but not labelled), adhesives, other mechanical connectors, or the like secure transfer platform 54 to wing rail 52. Bushings, rubber mounts, washers or the like may be placed between rail 52 and platform 54. One skilled in the art will appreciate that there are optional means for connecting the wing to the frame. In addition, the transfer platform can also be secured to the wing rail in other ways without departing from the scope of the present invention.

FIG. 3 provides a rear view that illustrates left wing 50 in a substantially horizontal or transfer position and right wing 52′ in a substantially vertical or upright position. From this perspective, there is illustrated a secondary pivot connection for each wing provided by a pair of rear bolts 62, 62′. These bolts connect the wings to rear bar 20 at the corresponding corners. Again, one skilled in the art will appreciate that the wings can be secured in a pivoting relationship to the frame via other mechanisms. It should be noted that, depending on the precise placement of the bolts used to secure the wings to front and rear bars 14 and 20, and also the placement of left and right bars 16, 18, the wing rails may be at least partially supported by left and right bars 16, 18 when the wings are substantially horizontal relative to the seating platform. In addition, as the frame may include cross members (not shown) to support receptacle 46, the ends of the wing rails may also be prevented rotating upwards by coming into contact with the optional, receptacle supporting cross members. Therefore, in at least one preferred embodiment, the frame prevents the wings from rotating to a position less then horizontal with respect to the seating platform. In this preferred embodiment, the frame acts as a brace to at least partially support a patient's weight during transfer. However, additional embodiments are envisioned whereby the wing is rotatable to a negative angle relative to the seating platform.

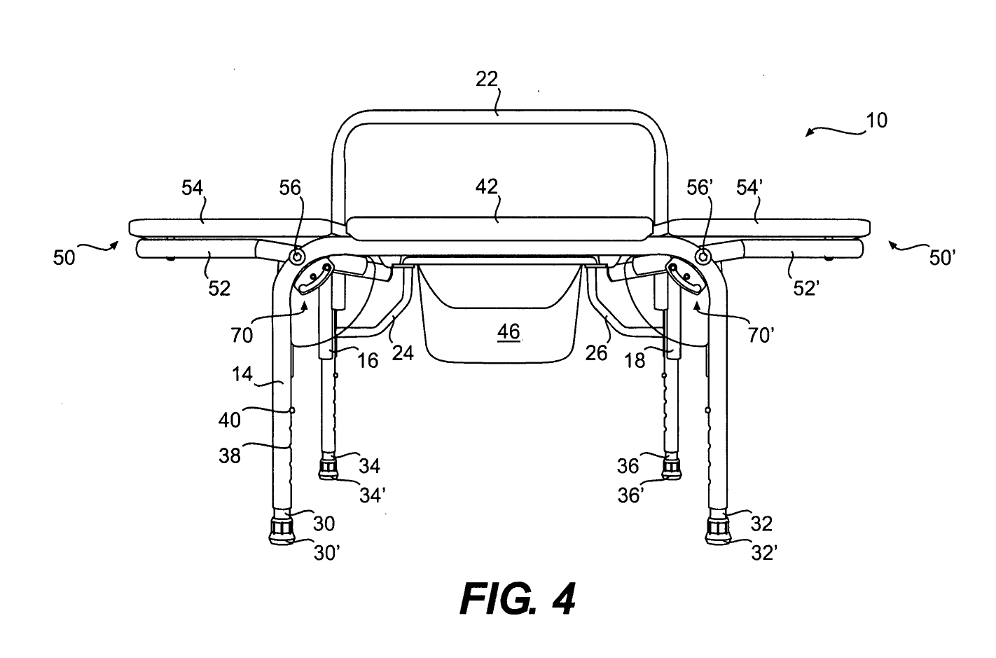

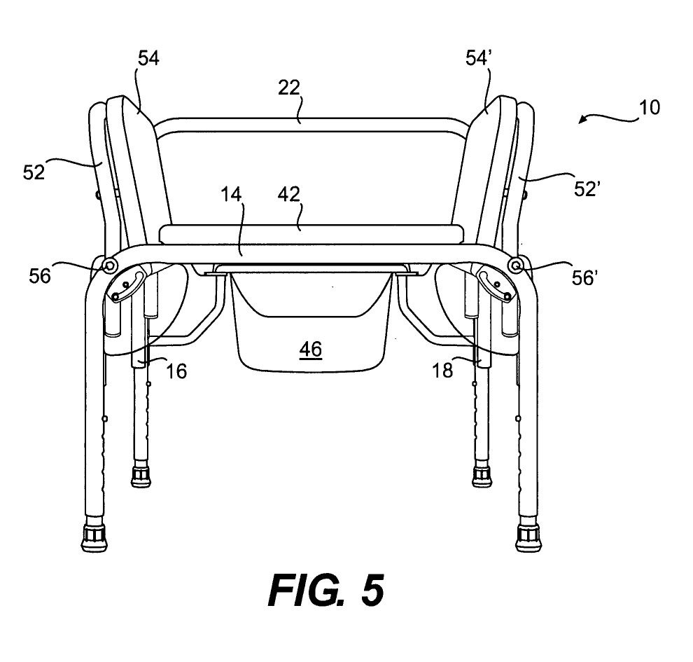

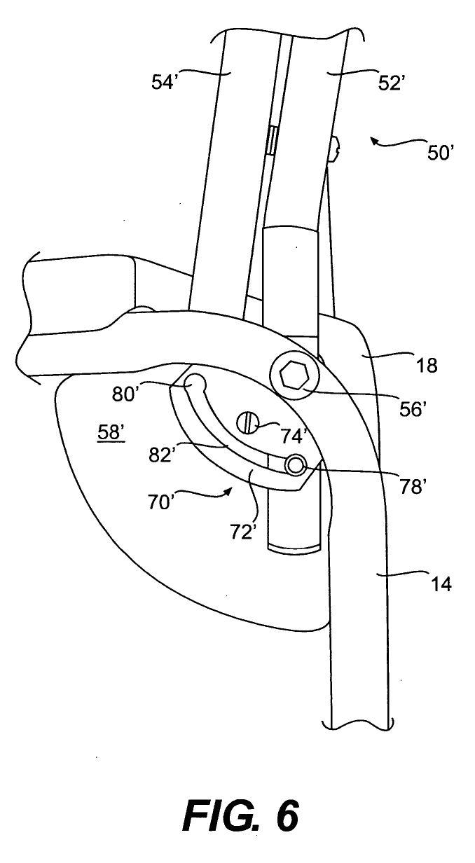

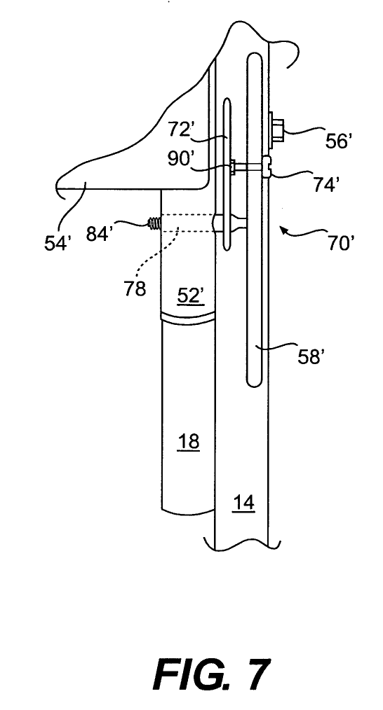

FIGS. 4 and 5 provide front, planar views of one preferred embodiment of transfer seat 10 wherein covers 58, 58′ are rendered transparent for the purposes of illustrating the invention. In these views, there is illustrated dual locking mechanisms 70, 70′ (described below and illustrated in FIGS. 6 and 7). FIGS. 4 and 5 illustrate the function of the locking mechanism in a preferred embodiment wherein wings 50, 50′ move from, and are locked, the transfer position (FIG. 4) to the up position (FIG. 5). It is also envisioned that the wing could rotate past these positions and/or that additional locking positions would be provided.

Locking mechanism 70′ is illustrated in greater detail in FIGS. 6 and 7 wherein FIG. 6 is a front, close-up view of locking mechanism for the right wing 50′ and FIG. 7 is view of the same taken from the left side of the mechanism. Mechanism 70′ includes a catch plate 72′ secured to front bar 14 by welding, fasteners, adhesive, or the like. Plate 72′ is secured in the upper, rounded, right hand corner of the generally U-shaped front bar 14. The plate is planar and is arranged transverse to the wing's axis of rotation. Plate 72′ includes at least one diametrical or annular opening 80′. An arched slot 82′ is defined by plate 72′ with both ends of the slot terminating within the surface area provided by plate 72′. At least one end of slot 82′ terminates at an opening 80′. Any additional openings would be located along slot 82′, as will be explained further below.

A screw 74′ is located in an aperture in plate 72′. The screw threads into a nut 90′ brazed or otherwise secured to plate 72′. Screw 74′ passes through, and supports, cover 58′. Cover 58′ is so mounted that it can slide along or rotate about screw 74′. Therefore, cover 58′ can be actuated, causing it to move towards plate 72′. In this preferred embodiment, pressing the cover is intended to actuate the locking mechanism, as described further below.

As previously described, wing rail 52′ rotates relative to the transfer seat's frame. Bolt 56′ passes through front bar 14 and wing rail 52′. A spring biased plunger 78′ passes through the wing rail in order to engage catch plate 72′. When fully engaged, one end of the plunger is in contact with cover 58′.

Plunger 78′ is, in a preferred embodiment, generally cylindrical shaped with to two diameters provided along the length of the plunger. A preferably frustoconical cam surface is defined between the two diameter sections. The forward facing end of the plunger 78′ is the narrower portion. The spring biasing means (not shown) may be mounted within wing rail 52′ so that the plunger is adapted to resist the retraction of the plunger away from plate 72′. However, the spring biasing means would prevent the plunger from being fully retracted into wing rail 52′ and would, in an unengaged state, create a natural bias that forces the plunger towards the plate. Illustrative spring biasing mechanisms are disclosed in U.S. Pat. No. 4,518,002 and 4,640,301, which are incorporated herein by reference. It should be understood, however, that other spring biasing mechanisms are available as would be obvious to one skilled in the art.

The spring biasing mechanism naturally forces the large diameter section of plunger 78′ into opening 80′. The diameter of this portion of the plunger is less than the diameter of opening 80′ but is greater than the width of slot 82′. Therefore, wing rail 52′ cannot be rotated from this position without retracting or pushing the large portion of plunger 78′ clear of opening 80′. Wing 50′ is effectively locked in placed.

In order to rotate wing 50′, a patient actuates plunger 78′ by pressing against the face of cover 58′ and then rotating the wing. The face can be released once the rotation causes the plunger to not be aligned with an opening 80′. The smaller diameter portion of the plunger moves along the path provided by slot 82′. The plunger then naturally re-engages an opening once the plunger is realigned with the opening or one of the openings. The slot terminates at both ends at openings. Locking mechanism 70′ is, therefore, operable to lock wing 50′ in two positions. In the up position, the wing simulates an arm rail. In the down position, the wing facilitates a patient's transfer onto the seating platform. It is envisioned that additional openings could be included along the path of the slot, as desired (e.g., the wing could be locked at a 45 degree angle relative to the seating platform). It also envisioned that only one opening could be provided.

It is thought that pressing cover 58′ to actuate mechanism 70′ will facilitate use of the wing and prevent injuries to patients. One skilled in the art will appreciate that alternative solutions could be derived that fall within the scope of the present invention, as claimed below. For instance, a set of threads 84′ on the plunger could be provided in order to secure a handle (not shown) on the plunger. A patient would then actuate plunger 78′ by pulling the handle away from wing rail 52′. Other modifications, including eliminating slot 82′, repositioning the various elements, and the like, are envisioned

Although the present invention has been described in terms of one or more preferred embodiments, it will be understood that numerous variations and modifications may be made without departing from the invention. Thus, for example, the transfer seat frame, seating platform, wing and the like can take numerous shapes other than the illustrated and described embodiments. The elements of the transfer seat could also be formed from numerous materials and fastened together using various known fasteners, including heat bonding, welding, screws or the like. Additional embodiments will become apparent to one skilled in the art. Thus, it is to be understood that within the scope of the appended claims, the invention may be practiced otherwise than as specifically described above.

What is claimed is:

1. A transfer seat comprising:
a frame;
a receptacle for human waste;
a seating platform supported by said frame, said seating platform including an opening;
a receptacle for human waste positioned beneath said seating platform, said opening in said seating platform allowing human waste to pass to said receptacle;
a wing adjacent to said seating platform, said wing being rotatable through a plurality of positions relative to said frame; and
said wing providing a transfer platform operable to support a patient transferring to said seating platform from the side of said transfer seat.

2. The transfer seat of claim 1, further comprising a releasable locking assembly adapted to releasably lock said wing in one or more positions with respect to said frame.

3. The transfer seat of claim 2, wherein said wing and said locking assembly are secured to said frame.

4. The transfer seat of claim 3, said releasable locking assembly comprising a spring biased plunger and a catch plate.

5. The transfer seat of claim 4, wherein said frame prevents said wing from rotating to a position less than substantially horizontal with respect to said seating platform.

6. The transfer seat of claim 1, further comprising a plurality of legs selectively extendible from said frame, said legs supporting said frame upon a support surface and operable to adjust the height of said frame from said support surface.

7. The transfer seat of claim 6, further comprising a releasable locking assembly adapted to releasably lock said wing in one or more positions with respect to said frame.

8. The transfer seat of claim 1, wherein said frame prevents said wing from rotating to a position less than substantially horizontal with respect to said seating platform.

9. The transfer seat of claim 1, wherein said receptacle is an installed toilet.

10. The transfer seat of claim 9, further comprising a waste diverting splash guard aligned between said opening and said installed toilet.

11. The transfer seat of claim 1, wherein said receptacle is selectively attached to said transfer seat so as to capture human waste passed through said opening.

12. A transfer seat comprising:
a frame;
a plurality of selectively extendible legs supporting said frame upon a support surface and operable to adjust the height of said frame from said support surface;
a seating platform supported by said frame, said seating platform including an opening;
a receptacle for collecting human waste beneath said seating platform, said opening in said seating platform allowing human waste to pass to said receptacle;
a wing adjacent to said seating platform; and
wherein said wing is moveable between a plurality of positions.

13. The transfer seat of claim 2, further comprising a transfer platform secured to said wing.

14. The transfer seat of claim 13, further comprising a releasable locking assembly mounted on said frame adapted to releasably lock said wing in one or more positions with respect to said frame.

15. The transfer seat of claim 12, further comprising a releasable locking assembly mounted on said frame adapted to releasably lock said wing in one or more positions with respect to said frame.

16. The transfer seat of claim 15, said releasable locking assembly comprising a spring biased plunger and a catch plate.

17. The transfer seat of claim 12, wherein said frame prevents said wing from rotating to a position less than substantially horizontal with respect to said seating platform.

18. The transfer seat of claim 12, wherein said receptacle is an installed toilet.

19. The transfer seat of claim 18, further comprising a waste diverting splash guard aligned between said opening and said installed toilet.

20. The transfer seat of claim 12, wherein said receptacle is selectively attached to said transfer seat so as to capture human waste passed through said opening.

21. A transfer seat comprising:
a frame
a seating platform supported by said frame over said receptacle, said seating platform including an opening;
a receptacle for collecting human waste beneath said seating platform, said opening in said seating platform allowing human waste to pass to said receptacle;
a wing attached to said frame adjacent to said seating platform, said wing is rotatable between a plurality of positions;
a releasable locking assembly mounted on said frame adapted to releasably lock said wing in one or more positions with respect to said frame; and
said releasable locking assembly comprising a spring biased plunger and a catch plate.

22. The transfer seat of claim 21, further comprising a transfer platform secured to said wing.

23. The transfer seat of claim 21, further comprising a plurality of selectively telescoping legs supporting said frame upon a support surface.

24. The transfer seat of claim 23, wherein said frame prevents said wing from rotating to a position less than substantially horizontal with respect to said seating platform.

25. The transfer seat of claim 21, wherein said receptacle is an installed toilet, further comprising a waste diverting splash guard aligned between said opening and said installed toilet.

26. The transfer seat of claim 21, wherein said receptacle is selectively attached to said transfer seat so as to capture human waste passed through said opening.

27. The method of using a wing on a transfer seat, the method comprising the steps of:
providing a portable commode including a frame, a human waste receptacle, a seating platform, and a wing adjacent to said seating platform;
locking said wing in a first up position to simulate a handrail;
actuating a locking mechanism;
rotating said wing to a second transfer position so that said locking mechanism automatically locks said wing in said second position; and
transferring a user to said seating platform via said wing.
